(19) United States
(12) Patent Application Publication
(10) Pub. No.: US 2020/0079297 A1
(43) Pub. Date: Mar. 12, 2020

(54) SELF-ALIGNMENT SYSTEM FOR ATTACHING A TRIM PANEL TO A VEHICLE DOOR ASSEMBLY

(71) Applicant: GM Global Technology Operations LLC, Detroit, MI (US)

(72) Inventors: Jesus Edgar Dominguez Cuevas, Jiutepec (MX); Alejandro Barrera Torres, Metepec (MX); Eliel Ramirez Palacios, Toluca (MX); Alejandro Valencia Angeles, Calimaya (MX)

(21) Appl. No.: 16/126,329

(22) Filed: Sep. 10, 2018

(51) Int. Cl. B60R 13/02

(52) U.S. Cl. CPC B60R 13/0206; B60R 13/0243

(57) ABSTRACT

A self-alignment system for attaching a trim panel to a vehicle door assembly is provided. The system includes a trim panel having an interior surface defining a housing platform, at least one alignment pin extending from the housing platform, and at least one locator pin adjacent the alignment pin. The system further includes an inboard door panel defining a plurality of through-holes configured to receive the alignment and locator pins. The alignment pin includes a rigid base portion extending integrally from the housing platform and a bifurcated resilient tapered portion extending integrally from the rigid base portion to a distal end. The rigid base portion includes an outer annular shell and an inner annular shell concentrically disposed within the outer annular shell. The bifurcated resilient tapered portion includes a first-half tapered portion and a second-half tapered portion defined by a plurality of ribs.

### INTRODUCTION

The present disclosure relates to a system for attaching an interior trim panel to a vehicle door, more particularly to the interior trim panel having an auto-alignment pin.

Automobile door assemblies generally include a passenger compartment door assembly having an outboard door panel that serves as an exterior surface of the automobile and an opposite inboard door panel onto which a trim panel is joined. The outboard and inboard door panels are usually formed of a metallic material such as sheet steel or sheet aluminum. A typical trim panel is a rigid or semi-rigid panel formed of a molded plastic material having a finished exterior surface that faces the interior of the passenger compartment and an opposite interior surface that is attached to the inboard door panel.

A trim panel is typically attached to the inboard door panel by a plurality of panel fasteners, such as push-in fasteners, inserted through corresponding apertures, or through-holes, defined in the inboard door panel. The push-in fasteners are normally preassembled to the interior surface of the trim panel, and the subassembly so formed are then secured to the inboard door panel. The push-in fasteners extend outward from the interior surfaces of the trim panels and are spaced apart adjacent the peripheral edge of the trim panel. The trim panels are attached to the inboard door panels by aligning and pushing the push-in fasteners on the inner trim panels into the corresponding through-holes in the door panels. The corresponding through-holes which are configured to receive the push-in fasteners and to cooperate with features of the push-in fasteners to retain the inner trim panel onto the inboard door panel.

Prior to the assembly of the trim panels to the inboard door panels, the trim panels may experience structural stress due to the packaging of the trim panels during shipping, extreme temperature changes, and/or continued curing of the molded door panels that may cause minor dimensional distortion of the trim panels such as warping of the trim panels. The minor dimensional distortion of the trim panels does not compromise the structural or aesthetic integrity of the trim panels, but may be sufficient to cause a slight misalignment of the preassembled push-in fasteners when the trim panels are being assembled to the inboard door panel. The slight misalignment of the push-in fasteners may require additional force to insert the push-in fasteners into the through-holes

Thus, while the current system of aligning and pushing the push-in fasteners on the inner trim panels into the corresponding through-holes in the door panels to attach the trim panels to the inboard door panels achieve their intended purpose, there is a need for a system that improves the aligning of the push-in fasteners to the corresponding through holes during the assembly process.

### SUMMARY

According to several aspects, a self-aligning trim panel is provided. The trim panel includes an interior surface defining a housing platform and at least one alignment pin. The alignment pin includes a rigid base portion extending integrally from the housing platform and a resilient tapered portion extending integrally from the rigid base portion to a distal end.

In an additional aspect of the present disclosure, the resilient tapered portion of the alignment pin is bifurcated into a first-half tapered portion and a second-half tapered portion.

In another aspect of the present disclosure, the trim panel further includes at least one push-in type fastener assembled onto the interior surface of the trim panel proximal to the housing platform. The push-in type fastener includes a distal end closer to the trim panel than the distal end of the alignment pin.

In another aspect of the present disclosure, the rigid base portion includes an outer annular shell and an inner annular shell concentrically disposed within the outer annular shell.

In another aspect of the present disclosure, at least one of the outer annular shell and the inner annular shell includes an oval annular cross-section.

In another aspect of the present disclosure, the alignment pin further includes a first set of ribs interconnecting the outer annular shell and the inner annular shell. The first set of ribs extends from the outer and inner annular shell tapering toward a first-half distal end thereby defining the first-half tapered portion.

In another aspect of the present disclosure, the first set of ribs includes a center rib disposed between a pair of support ribs spaced from the center ribs. The center rib includes a ramp surface extending from the first-half distal end to an exterior surface of the outer annular shell.

In another aspect of the present disclosure, at least one of the support ribs includes a ramp surface extending from the distal end to an edge surface of the outer annular shell.

In another aspect of the present disclosure, the trim panel defines a first quadrant and second quadrant located in a first-half portion of the interior surface of the trim panel; and a third quadrant and fourth quadrant located in a second-half portion of the interior surface of the trim panel. A first and second locator pin is disposed within the first and second quadrants, respectively, and each of the third and fourth quadrant includes at least one of the alignment pin.

In another aspect of the present disclosure, the locator pins and alignment pins are injection molded with the trim panel as an integral unit.

According to several aspects, an auto-alignment pin for a trim panel is disclosed. The auto-alignment pin includes a rigid base portion having an outer annular shell and an inner annular shell concentrically disposed within the outer annular shell and a bifurcated portion extending integrally from the rigid base portion. The bifurcated portion includes a first-half tapered portion and a second-half tapered portion.

In another aspect of the present disclosure, the alignment pin further includes a first set of ribs and a second set of ribs interconnecting the outer annular shell and the inner annular shell. The first set of ribs extends tapering toward a first-half distal end, thereby defining the first-half tapered portion. The first-half tapered portion is spaced from the second-half tapered portion such that the first-half distal end and second-half distal end are resiliently deformable to one another.

According to several aspects, the first set of ribs includes a center rib having a ramp surface extending from the first-half distal end to an exterior surface of the outer annular shell.

In another aspect of the present disclosure, the central rib is disposed between a pair of support ribs spaced from the center rib. At least one of the support ribs includes a ramp surface extending from the first-half distal end to an edge surface of the outer annular shell.

In another aspect of the present disclosure, the alignment pin is integrally injection molded with the trim panel.

According to several aspects, a self-alignment system for attaching a trim panel to an inboard door panel is provided. The system includes a trim panel having an interior surface defining a first and second upper quadrants, and a third and fourth lower quadrants; a locator pin extending away from the interior surface in each of the two upper quadrants; an alignment pin extending away from the interior surface in each of the two lower quadrants; and an interior door panel having corresponding locator pin through-holes configured to receive the locator pins in each of the upper quadrants and corresponding alignment pin through-holes configured to receive the alignment pins in each of the lower quadrants. The alignment pin includes a rigid base portion extending integrally from the interior surface and a bifurcated tapered portion extending integrally from the rigid base portion toward a distal end.

In another aspect of the present disclosure, one of the locator pin through-holes defines a circular shape cross-section and the other of the locator pine through-holes define an obround shape, and the alignment pin through-holes defines an obround shape.

According to several aspects, the trim panel, the locator pins, and the alignment pins are integrally molded into a single unit. The inboard door panel is formed of a metallic material.

In another aspect of the present disclosure, at least one of the obround shape includes two parallel edges extending in the horizontal direction, and the width between the two parallel edges is sufficient to receive and then retain the alignment pin.

In another aspect of the present disclosure, the interior surface of the trim panel includes a plurality of push in type fasteners. At least one of the fasteners is adjacent to one of the alignment pins.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a partial perspective view of a door assembly having a trim panel having a fish-mouth auto-alignment pin spaced from an inboard door panel, according to an exemplary embodiment;

FIG. 2 is a perspective view of the fish-mouth auto-alignment pin of FIG. 1, according to an exemplary embodiment;

FIG. 3 is an end view of the fish-mouth auto-alignment pin of FIG. 2, according to an exemplary embodiment;

FIG. 4 is a schematic view of an interior surface of a trim panel, according to an exemplary embodiment; and

FIG. 5 is a schematic view of an inboard door panel, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

FIG. 1 shows a partial perspective view of a door assembly, generally indicated with reference number 100, having a trim panel 102 spaced from an inboard door panel 104. The trim panel 102 is attached to the inboard door panel 104 by a plurality of panel fasteners 106, such as push-in fasteners 106. Examples of push-in fasteners 106 include, but are not limited to, nylon push fasteners, Christmas tree fasteners, rivet clips fasteners, etc. The push-in fasteners 106 are normally preassembled into fastener slots 108 defined on an interior surface 110 of the trim panel 102. The push-in fasteners 106 extend outward from the interior surface 110 of the trim panel 102 and are spaced apart adjacent the peripheral edge 112 of the trim panel 102. The inboard door panel 104 defines corresponding fastener through-holes 114 which are aligned to receive the push-in fasteners 106 preassembled on the trim panel 102. The trim panel 102 is attached to the inboard door panel 104 by first aligning the trim panel 102 to the inboard door panel 104 and then pushing the trim panel 102 toward the inboard door panel 104 until the push-in fasteners 106 are fully inserted into the corresponding through-holes 114.

The door assembly 100 includes at least one auto-alignment pin 116, also referred to as a fish-mouth alignment pin 116 or alignment pin 116, to ensure proper positioning of the trim panel 102 to the inboard door panel 104 during the assembly process for minimizing or eliminating any dimensional distortion, or warping, of the trim panel 102, thus providing proper alignment of the push-in fasteners 106 to the corresponding through-holes. The auto-alignment pin 116 extends from a housing platform 118 defined on the interior surface of the trim panel 102. The auto-alignment pin 116, housing platform 118, and trim panel 102 is molded as a signal integral unit, thus any force applied to the auto-alignment pin is transmitted though the housing platform 118 to the trim panel 102. The auto-alignment pin 116 includes a distal end 120 that extends further apart from the peripheral edge 112 of the trim panel 102 than any one of the distal ends 122 of the push-in fasteners 106.

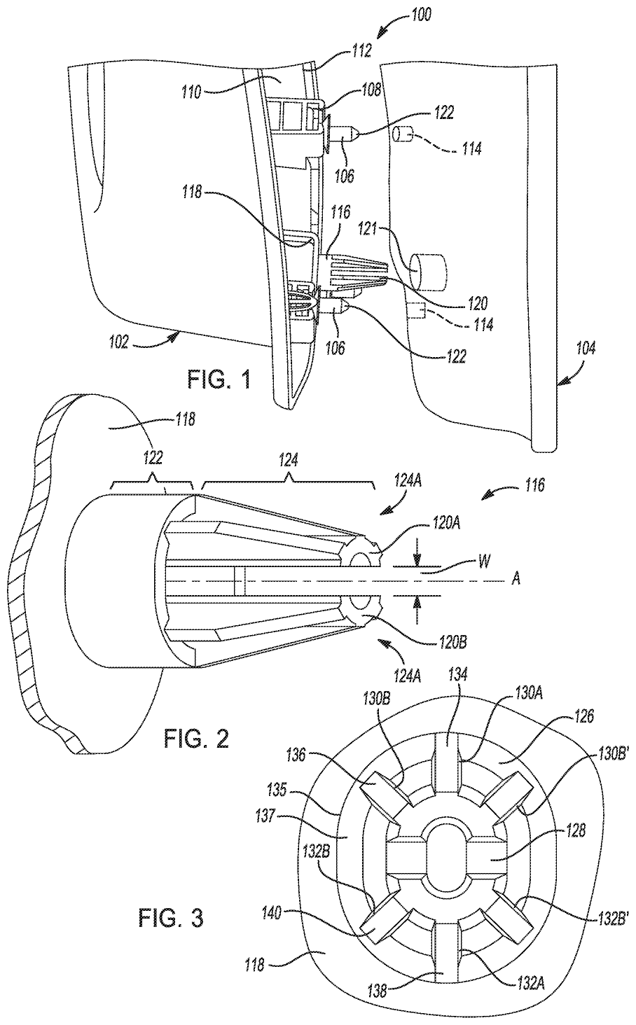

FIG. 2 shows a perspective view of the auto-alignment pin extending along an A-axis and FIG. 3 shows an end view of the auto-alignment pin of FIG. 2. Referring to both FIGS. 1 and 2, the auto-alignment pin includes a rigid base portion 122 extending from the housing platform 118 and a resilient tapered portion 124 extending from the base portion 122 to the distal end 120. The tapered portion 124 is bifurcated into a first-half tapered portion 124A, shown above the A-axis, and a second-half tapered portion 124B, shown below the A-axis, thereby defining an axial space between the first-half tapered portion 124A and the second-half tapered portion 124B. The axial space includes a sufficient width (W) such that a first-half distal end 120A of the first-half tapered portion 124A and a second-half distal end 120B of the second-half tapered portion 124B can be resiliently deformed toward the A-axis thereby reducing the cross-sectional profile of the distal end 120.

The base portion 122 of the auto-alignment pin is defined by an outer annular shell 126 disposed about the A-axis and an inner annular shell 128 concentrically disposed within the outer annular shell 126. The auto-alignment pin includes a first set of ribs 130A, 130B, 130B′ interconnecting the outer annular shell 126 and the inner annular shell 128, thereby further increasing the structural integrity and rigidity of the base portion 122. The first set of ribs 130A, 130B, 130B′ extends from the outer and inner annular shells 126, 128 tapering toward the first-half distal end 120A where the first set of ribs 130A, 130B, 130B′ are jointed together. The first set of ribs includes a center rib 130A disposed between two support ribs 130B, 130B′ spaced from the central rib 130A. The center rib 130A includes a tapered ramp surface 134 extending from the first-half distal end 120A to an exterior surface 135 of the outer annular shell 126. Each of the two support ribs 130B, 130B′ includes a tapered ramp surface 136 extending from the first-half distal end 120A to an edge surface 137 of the outer annular shell 126.

Similarly, a second set of ribs 132A, 132B, 132B′ interconnects the outer annular shell 126 and the inner annular shell 128 tapering toward the second-half distal end 120B where the second set of ribs 132A, 132B, 132B′ are joined. The second set of ribs 132A, 132B, 132B′ includes a center rib 132A disposed between two support ribs 132B, 132B′. The center rib 132A includes a tapered ramp surface 138 extending from the second-half distal end 120B to the exterior surface 135 of the outer annular shell 126. Each of the two support ribs 132B, 132B′ includes a tapered ramp surface 140 extending from the second-half distal end 120B to the edge surface 137 of the outer annular shell 126.

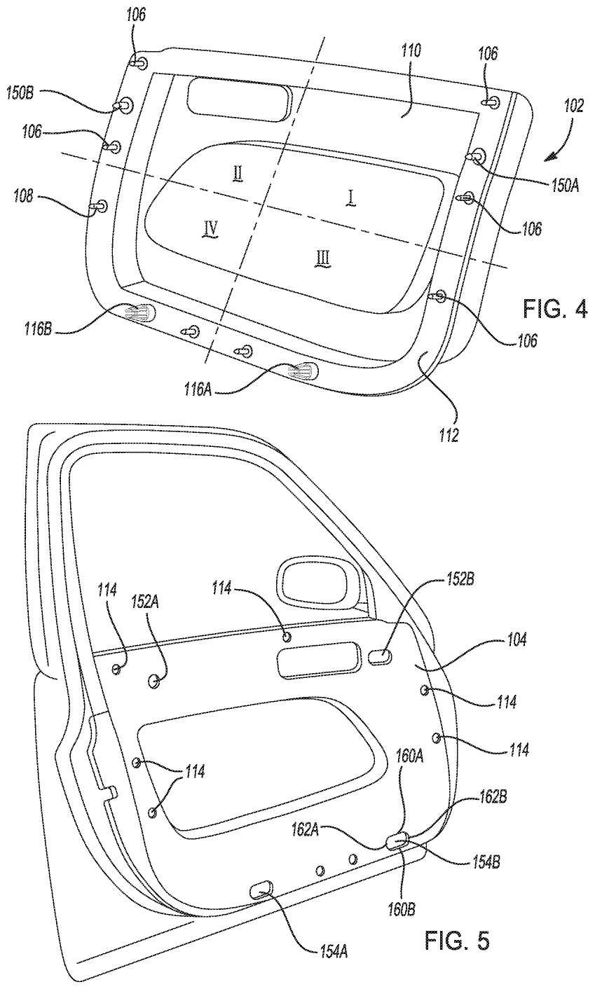

Shown in FIG. 4 and FIG. 5 is self-alignment system for attaching the trim panel 102 to the inboard door panel 104 of the vehicle door assembly 100. The system includes a plurality of locator pins 150A, 150B and auto-alignment pins 116A, 116B integrally injection molded with the trim panel 102 and a plurality of corresponding locator pin 150A, 150B through-holes 152A, 152B and alignment pin through-holes 154A, 154B defined in the inboard door panel 104 configured to receive the locator pins 150A, 150B and auto-alignment pins 116A, 116B, respectively. As disclosed in detail below, the locator pins 150A, 150B and auto-alignment pins 116A, 116B, are strategically positioned onto the interior surface 110 of the trim panel 102 such that as the trim panel 102 is attached to the inboard door panel 104, the locator pins 150A, 150B and auto-alignment pins 116A, 116B cooperates with the corresponding through-holes 152A, 152B, 154A, 154B to minimize or eliminate any dimensional distortion to the trim panel 102 thus properly aligning the push-in fasteners 106 with the corresponding fastener through-holes.

FIG. 4 shows an interior surface 110 of the interior trim panel 102. The interior surface 110 of the trim panel 102 includes a plural of push-in fasteners 106 preassembled into fastener slots 108 defined on the interior surface 110. The push-in fasteners 106 extend outward from the interior surface 110 of the trim panel 102 and are spaced apart adjacent the peripheral edge 112 of the trim panel 102. The trim panel 102 is shown divided into four quadrant including a first quadrant (I) and a second quadrant (II) located in an upper portion of the trim panel 102, and a third quadrant (Ill) and a fourth quadrant (IV) located in an lower portion of the trim panel 102.

The interior surface 110 of the trim panel 102 includes a first locator pin 150A and a second locator pin 150B molded within the first and second quadrant respectively, and a first auto-alignment pin 116A and a second auto-alignment pin 116B molded within the third and fourth quadrant, respectively. The locator pins 150A, 150B and auto-alignment pins 116A, 116B extend further from the interior surface 110 of the trim panel 102 than the push-in fasteners 106 thus ensuring the locator pins 150A, 150B and auto-alignment pins 116A, 116B engage the inboard door panel 104 before the push-in fasteners 106 engage the inboard door panel 104.

FIG. 5 shows the inboard door panel 104 having corresponding through-holes 114 configured to receive the push-in fasteners 106 provided on the trim panel 102. The inboard door panel 104 defines a circular through-hole 152A having includes a diameter larger than the outer diameter of the first locator pin 150A such that the first locator pin 150A is receivable and retainable within the circular through-hole 152A. The inboard door panel 104 also defines three obround through-hole 152B, 154A, 154B configured to receive the second locator pin 150B, first auto-alignment pin 116A, and second auto-alignment pin 116B, respectively. Each of the obround through-holes includes two horizontally extending parallel sides 160A, 160B and two semicircular ends 162A, 162B. The distance between the parallel sides 160A, 160B is greater than the diameter of the second locator pin 150B and the base portion 122 of the auto-alignment pin 116A, 116B such that the second locator pin 152B and base portion 122 is receivable and retainable between the two parallel sides 160A, 160B, but yet slidable between the semicircular ends 162A, 162B.

The trim panel 102 is attached to the inboard door panel 104 by first aligning the locator pins 150A, 150B and auto-alignment pins 116A, 116B to the corresponding through-holes defined in the inboard door panel 104 and then pushing the trim panel 102 toward the interior door panel 104. The first and second locator pin 150A, 150B cooperate with each other to vertically and horizontally position the trim panel 102 onto the inboard door panel 104. The first and second auto-alignment pins 116A, 116B cooperate with the first and second locator pin 150A, 150B to remove any distortion of the trim panel 102.

During the initial insertion of the auto-alignment pins 116A, 116 the tapered portion 124 of the auto-alignment pins cooperates with the corresponding through-holes 154A, 154B such that the base portion 122 of the auto-alignment pins 116 is centered between the two parallel sides of the obround through-holes. The bifurcation of the tapered portion 124 provides additional elastic deformation to the tapered portion 124 such that the tapered portion 124 guides the rigid base portion 122 into the through-holes 154A, 154B. As the rigid base portion 122 is inserted into the through-holes 154A, 154B and makes contact with the inboard door panel 104, the rigid base portion 122 transmit the insertion force through the structural housing platform 118 and to the trim panel 102, thus minimizing or eliminating any dimensional distortion of the trim panel 102 and enabling the proper alignment of push-in fasteners 106 with the corresponding through-holes 116.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A trim panel comprising:
an interior surface defining a housing platform; and
at least one alignment pin comprising a rigid base portion extending integrally from the housing platform and a resilient tapered portion extending integrally from the rigid base portion to a distal end.

2. The trim panel of claim 1, wherein the resilient tapered portion of the alignment pin is bifurcated into a first-half tapered portion and a second-half tapered portion.

3. The trim panel of claim 2, further comprising at least one push-in type fastener assembled onto the interior surface of the trim panel proximal to the housing platform, the push-in type fastener includes a distal end closer to the trim panel than the distal end of the alignment pin.

4. The trim panel of claim 2, wherein the rigid base portion includes an outer annular shell and an inner annular shell concentrically disposed within the outer annular shell.

5. The trim panel of claim 4, wherein at least one of the outer annular shell and the inner annular shell includes an oval annular cross-section.

6. The trim panel of claim 4, wherein the alignment pin further includes a first set of ribs interconnecting the outer annular shell and the inner annular shell, and wherein the first set of ribs extends from the outer and inner annular shells tapering toward a first-half distal end thereby defining the first-half tapered portion.

7. The trim panel of claim 6, wherein the first set of ribs includes a center rib disposed between a pair of support ribs spaced from the center ribs, the center rib includes a ramp surface extending from the first-half distal end to an exterior surface of the outer annular shell.

8. The trim panel of claim 7, wherein at least one of the support ribs includes a ramp surface extending from the distal end to an edge surface of the outer annular shell.

9. The trim panel of claim 7, further comprising:
a first quadrant and second quadrant located in a first-half portion of the interior surface of the trim panel;
a third quadrant and fourth quadrant located in a second-half portion of the interior surface of the trim panel; and
a first and second locator pin disposed within the first and second quadrants, respectively;
wherein each of the third and fourth quadrant includes at least one of the alignment pin.

10. The trim panel of claim 9, wherein the locator pins and alignment pins are injection molded with the trim panel as an integral unit.

11. An auto-alignment pin for a trim panel, comprising:
a rigid base portion comprising an outer annular shell and an inner annular shell concentrically disposed within the outer annular shell; and
a bifurcated portion extending integrally from the rigid base portion, wherein the bifurcated portion includes a first-half tapered portion and a second-half tapered portion.

12. The auto-alignment pin of claim 11, further comprising:
a first set of ribs interconnecting the outer annular shell and the inner annular shell, wherein the first set of ribs extends tapering toward a first-half distal end, thereby defining the first-half tapered portion; and
a second set of ribs interconnecting the outer annular shell and the inner annular shell, wherein the second set of ribs extends tapering toward a second-half distal end, thereby defining the second-half tapered portion;
wherein the first-half tapered portion is spaced from the second-half tapered portion such that the first-half distal end and second-half distal end are resiliently deformable to one another.

13. The auto-alignment pin of claim 12, wherein the first set of ribs includes a center rib having a ramp surface extending from the first-half distal end to an exterior surface of the outer annular shell.

14. The auto-alignment pin of claim 13, wherein the central rib is disposed between a pair of support ribs spaced from the center rib, and wherein at least one of the support ribs includes a ramp surface extending from the first-half distal end to an edge surface of the outer annular shell.

15. The auto-alignment pin of claim 13 is integrally injection molded with the trim panel.

16. A self-alignment system for attaching a trim panel to a door assembly, comprising:
a trim panel having an interior surface defining a first and second upper quadrants, and a third and fourth lower quadrants;
a locator pin extending away from the interior surface in each of the two upper quadrants;
an alignment pin extending away from the interior surface in each of the two lower quadrants, the alignment pin comprising a rigid base portion extending integrally from the interior surface and a bifurcated tapered portion extending integrally from the rigid base portion toward a distal end;
an inboard door panel having corresponding locator pin through-holes configured to receive the locator pins in each of the upper quadrants and corresponding alignment pin through-holes configured to receive the alignment pins in each of the lower quadrants.

17. The self-alignment system of claim 16, wherein one of the locator pin through-holes defines a circular shape cross-section and the other of the locator pin through-holes defines an obround shape, and each of the alignment pin through-holes defines an obround shape.

18. The self-alignment system of claim 16, wherein the trim panel, the locator pins, and the alignment pins are integrally molded as a single unit; and wherein the inboard door panel is formed of a metallic material.

19. The self-alignment system of claim 18, wherein at least one of the obround shapes includes two parallel edges extending in the horizontal direction, and wherein the width between the two parallel edges is sufficient to receive and retain the alignment pin.

20. The self-alignment system of claim 20, wherein the interior surface of the trim panel includes a plurality of push in type fasteners, wherein at least one of the fasteners is adjacent to one of the alignment pins.
